(19) United States
(12) Patent Application Publication
(10) Pub. No.: US 2020/0285510 A1
(43) Pub. Date: Sep. 10, 2020

(54) HIGH PRECISION LOAD DISTRIBUTION AMONG PROCESSORS

(71) Applicant: FUJITSU LIMITED, Kawasaki-shi (JP)

(72) Inventor: Munenori MAEDA, Yokohama (JP)

(73) Assignee: FUJITSU LIMITED, Kawasaki-shi (JP)

(21) Appl. No.: 16/807,616

(22) Filed: Mar. 3, 2020

(30) Foreign Application Priority Data
Mar. 8, 2019 (JP) 2019-042231

(51) Int. Cl. G06F 9/48; G06F 9/50; G06F 9/54; G06F 7/58

(52) U.S. Cl. CPC G06F 9/4881; G06F 9/485; G06F 9/4837; G06F 7/588; G06F 9/5083; G06F 9/542; G06F 9/5038

(57) ABSTRACT

A plurality of processors are communicatively coupled to each other. Each of the plurality of processors is configured to independently execute a task distribution process that includes collecting processing capacities of the plurality of processors, and distribute a predetermined number of tasks to the plurality of processors with distribution probabilities corresponding to respective ratios of the collected processing capacities.

### CROSS-REFERENCE TO RELATED APPLICATION

This application is based upon and claims the benefit of priority of the prior Japanese Patent Application No. 2019-42231, filed on Mar. 8, 2019, the entire contents of which are incorporated herein by reference.

### FIELD

The embodiments discussed herein are related to high precision load distribution among processors.

### BACKGROUND

In order to increase the processing performance of a system including a plurality of processing units such as a multiprocessor system and a multicore system, it is important to control executions of tasks such that loads may be distributed among the processing units. Loads may be distributed by equally distributing tasks to the processing units. However, according to this method, a large unevenness of the load balance may occur among the processing units because of different details of tasks. Accordingly, there is another method that controls such that tasks are distributed to the processing units by probabilities based on ration of processing loads in the processing units.

With respect to the load distribution, there is a proposal as follows. For example, an information processing apparatus has been proposed that distributes transactions to a plurality of servers by using a registration table of transaction distribution destinations. The information processing apparatus generates the distribution destination registration table by calculating distribution ration of transactions based on relative ration of processing capacities of servers and using the distribution ration and an index table generated based on random numbers. As another example, a gateway processor has been proposed that generates a load distribution matrix based on operating ration of a plurality of CPUs and determines the CPU to be caused to execute a transaction by using the load distribution matrix.

Japanese Laid-open Patent Publication No. 9-282287 and Japanese Laid-open Patent Publication No. 9-259093 discuss related art.

### SUMMARY

According to an aspect of the embodiments, a plurality of processors are communicatively coupled to each other. Each of the plurality of processors is configured to independently execute a task distribution process that includes collecting processing capacities of the plurality of processors, and distribute a predetermined number of tasks to the plurality of processors with distribution probabilities corresponding to respective ratios of the collected processing capacities.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a configuration example and a processing example of an information processing apparatus according to a first embodiment;

FIG. 2 is a diagram illustrating a configuration example of a storage system according to a second embodiment;

FIG. 3 is a diagram illustrating a hardware configuration example of a storage control apparatus;

FIG. 4 is a block diagram illustrating a configuration example of processing functions that the storage control apparatus includes;

FIG. 5 is a diagram for explaining task distribution control based on ration of processing capacities of cores;

FIG. 6 is a diagram illustrating an example of information to be used for task distribution control;

FIG. 7 is a diagram for explaining processing of generating sequence;

FIG. 8 is an example of a flowchart illustrating a process of generating a random number table;

FIG. 9 is an example of a flowchart illustrating a task execution control process;

FIG. 10 is a first example of a flowchart illustrating task distribution control processing;

FIG. 11 is a second example a flowchart illustrating task distribution control processing;

FIG. 12 is an example of a flowchart illustrating a process of generating PeerSelector[i,*];

FIG. 13 is a diagram schematically illustrating how task distribution control is performed in cores;

FIG. 14 is an example of a flowchart illustrating task distribution control processing according to Variation Example 1;

FIG. 15 is an example of a flowchart illustrating task distribution control processing according to Variation Example 2;

FIG. 16 is a diagram illustrating a configuration example of a function-based cores and matrices to be used;

FIG. 17 is an example of a flowchart illustrating task distribution control processing according to Variation Example 3;

FIG. 18 is a diagram illustrating a configuration example of a function-based cores and sequences to be used according to Variation Example 4;

FIG. 19 is a diagram illustrating an example of core selection sequences for equal distribution;

FIG. 20 is an example of a flowchart illustrating a part of task distribution control processing according to Variation Example 4; and

FIG. 21 is an example of a flowchart illustrating a part of task distribution control processing according to Variation Example 5.

### DESCRIPTION OF EMBODIMENTS

The method that determines distribution destinations of a predetermined number of tasks by a probability based on ration of loads in a plurality of processing units at a certain point in time has following problems. According to this method, tasks are distributed by a probability based on ration of loads at a starting point in time of a period when a predetermined number of tasks are distributed. Therefore, when the load balance changes among the processing units during the period, the precision of the load distribution when the processing units process the distributed tasks decreases.

In one aspect, increasing precision of load distribution among a plurality of processing units is desirable.

Hereinafter, the embodiments will be described with reference to the drawings.

### First Embodiment

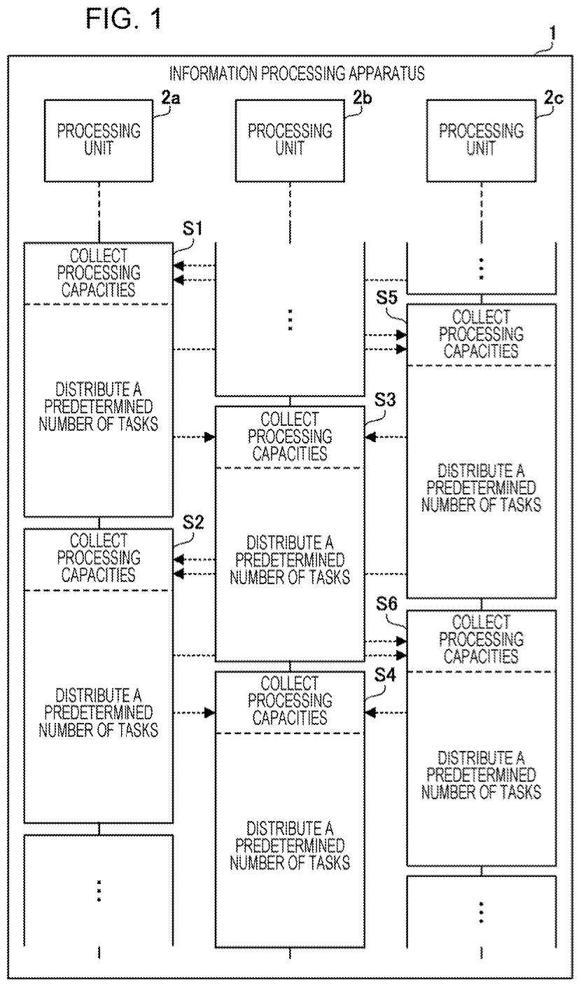

FIG. 1 is a diagram illustrating a configuration example and a processing example of an information processing apparatus according to a first embodiment. An information processing apparatus 1 illustrated in FIG. 1 includes processing units 2a to 2c. Each of the processing units 2a to 2c is, for example, a processor included in a multiprocessor system or a processor core included in a multicore processor.

Each of the processing units 2a to 2c independently executes task distribution processing, which will be described below, by handling a predetermined number of tasks as a unit. For example, the processing unit 2a collects processing capacities of the processing units 2a to 2c and distributes a predetermined number of tasks occurring in the processing unit 2a to the processing units 2a to 2c by a distribution probability based on the ration of the collected processing capacities. Also, each of the processing units 2b and 2c performs the same processing on a predetermined number of tasks occurring in each of the processing units 2b and 2c, The processing capacity to be collected is a reserve capacity for processing in a processing unit and is, for example, calculated as a value acquired by subtracting a usage rate (busy rate) of a processor or a processor core from 100%.

In such task distribution processing, a predetermined number of tasks may be distributed such that processing loads on the processing units 2a to 2c are leveled based on the ration of the processing capacities of the processing units 2a to 2c upon start of the task distribution processing. However, in the task distribution processing by each of the processing units, a predetermined number of tasks are distributed by using one distribution probability calculated at the beginning of a period when the predetermined number of tasks occur. Even when the load balance changes among the processing units 2a to 2c within a period when a predetermined number of tasks occur in one processing unit, a new distribution probability is not calculated until the period ends. Therefore, in a case where only one of the processing units executes the task distribution processing by the procedure described above, the precision of leveling of the load balance disadvantageously decreases when the load balance changes among the processing units 2a to 2c within a period when a predetermined number of tasks occur.

On the other hand, according to this embodiment, as illustrated in FIG. 1, the task distribution processing on a predetermined number of tasks as described above is independently performed by each of the processing units 2a to 2c. There is a possibility that the stages of progress of the task distribution processing of each set of the predetermined number of tasks vary among the processing units 2a to 2c. For example, when one processing unit executes a task, new tasks to be distributed are generated because of the execution of the task. In this case, for some details of processing of the task to be executed, a predetermined number of tasks are generated with the execution of the task, and the time required for distributing the tasks differs. Because of the time differences, the stages of progress of the task distribution processing for each set of a predetermined number of tasks vary among the processing units 2a to 2c.

As a result, in the middle of a period when one processing unit distributing a predetermined number of tasks by calculating the distribution probability, another processing unit calculates the distribution probability again and distributes another predetermined number of tasks based on the distribution probability. Thus, the frequency of calculation of the distribution probability increases as a whole of the information processing apparatus 1, and the times for calculating the distribution probability are dispersed.

In the example, in FIG. 1, the processing unit 2a executes processing of distributing a predetermined number of tasks (step S1) and then executes processing of distributing another predetermined number of tasks (step S2). After the task distribution processing in step S1 by the processing unit 2a is started, the processing unit 2b executes processing of distributing another predetermined number of tasks (step S3) and then executes processing of distributing another predetermined number of tasks (step S4). After the task distribution processing in step S1 by the processing unit 2a is started, the processing unit 2c executes processing of distributing another predetermined number of tasks (step S5) and then executes processing of distributing another predetermined number of tasks (step S6).

In this example, during a period when the processing unit 2a is executing processing of distributing a predetermined number of tasks (step S1), the processing unit 2c in the processing in step S5 collects the processing capacities of the processing units 2a to 2c, calculates a distribution probability again and distributes another predetermined number of tasks based on the distribution probability. After the processing in step S5 is started during the period, the processing unit 2b in the processing in step S3 collects the processing capacities of the processing units 2a to 2c, calculates the distribution probability again and distributes another predetermined number of tasks based on the distribution probability.

As a result, during the period when the processing unit 2a is executing the processing of distributing a predetermined number of tasks (step S1), the other processing units 2b and 2c collect the processing capacities of the processing units 2a to 2c and re-calculate the distribution probability a plurality of number of times. Based on the distribution probability, task distribution processing is executed. Therefore, the frequency of the calculation of the distribution probability based on the results of the collection of processing capacities of the processing units 2a to 2c increases. Because of the execution of the task distribution control based on the distribution probability calculated at a high frequency, tasks are distributed to proper distribution destinations by rapidly following changes of the load balance among the processing units 2a to 2c. This may improve the precision of the load distribution among the processing units 2a to 2c.

### Second Embodiment

A storage system applying a storage control apparatus as an example of the information processing apparatus 1 illustrated in FIG. 1 will be described next.

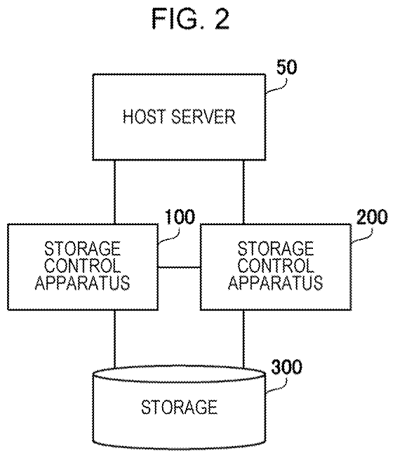

FIG. 2 is a diagram illustrating a configuration example of a storage system according to a second embodiment. As illustrated in FIG. 2, the storage system according to the second embodiment includes a host server 50, storage control apparatuses 100 and 200, and a storage 300. The storage control apparatuses 100 and 200 are examples of the information processing apparatus 1 illustrated in FIG. 1.

The host server 50 is, for example, a server computer that executes processes such as a business process. The storage control apparatuses 100 and 200 process an input/output (I/O) request received from the host server 50. For example, one or more logical volumes to be accessed from the host server 50 are generated by using a storage area of the storage 300. The storage control apparatuses 100 and 200 receive an I/O request from the host server 50 to a logical volume and control an I/O process on the logical volume. The storage control apparatuses 100 and 200 are implemented as server computers, for example. In this case, the storage control apparatuses 100 and 200 execute storage control by executing an application program for storage control. One or more non-volatile storage devices are mounted in the storage 300. For example, a solid state drive (SSD) is mounted in the storage 300 as a non-volatile storage device.

The host server 50 and the storage control apparatuses 100 and 200 are coupled by using a Fibre Channel (FC) or an Internet Small Computer System Interface (iSCSI), for example. The storage control apparatuses 100 and 200 are coupled by using an FC, an iSCSI or a local area network (LAN), for example. The storage control apparatuses 100 and 200 that are mutually coupled allow data distribution arrangement and data duplexing (data copy from one to the other), for example. The storage control apparatuses 100 and 200 and the storage 300 are coupled with each other by using an FC, an iSCSI, or a Serial Advanced Technology Attachment (SATA), for example.

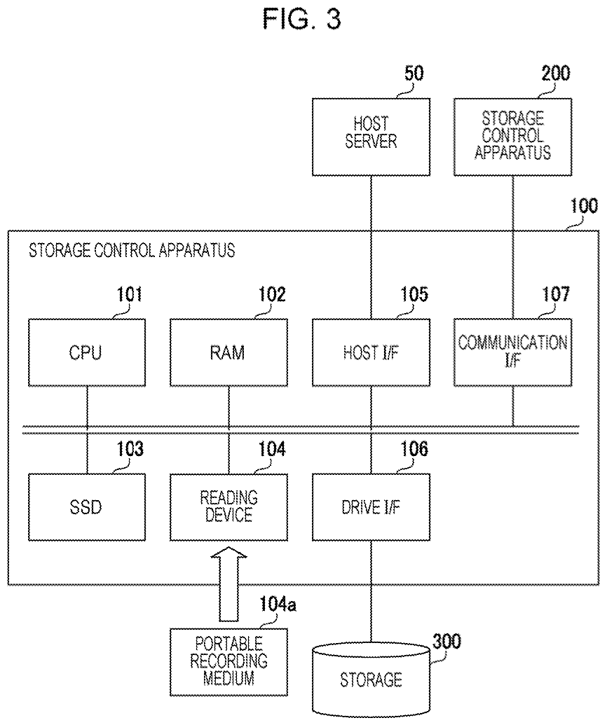

FIG. 3 is a diagram illustrating a hardware configuration example of the storage control apparatus. FIG. 3 exemplarily illustrates a hardware configuration of the storage control apparatus 100, but the storage control apparatus 200 is also implemented by the same hardware configuration as that of the storage control apparatus 100.

The storage control apparatus 100 has a central processing unit (CPU) 101, a random-access memory (RAM) 102, an SSD 103, a reading device 104, a host interface (I/F) 105, a drive interface (I/F) 106, and a communication interface (I/F) 107.

The CPU 101 is a processing device that reads and processes a program from the RAM 102. The CPU 101 is a multicore CPU including a plurality of cores (processor cores).

The RAM 102 is used as a main storage device for the storage control apparatus 100. Any one or any combination of an operating system (OS) program and application programs, which are executed by the CPU 101, is temporarily stored in the RAM 102. In the RAM 102, there are stored various data required for processing by the CPU 101.

The SSD 103 is used as an auxiliary storage device for the storage control apparatus 100. In the SSD 103, there are stored OS programs, application programs, and various data. As the auxiliary storage device, other types of non-volatile storage device may be used such as a hard disk drive (HDD).

A portable recording medium 104a is attached and detached to the reading device 104. The reading device 104 reads data recorded on the portable recording medium 104a and transmits the data to the CPU 101. Examples of the portable recording medium 104a include an optical disk, a magneto-optical disk, a semiconductor memory, and the like.

The host interface 105 is an interface device for communicating with the host server 50. The drive interface 106 is an interface device for communicating with a non-volatile storage device included in the storage 300. The communication interface 107 is an interface device for communicating with the other storage control apparatus 200.

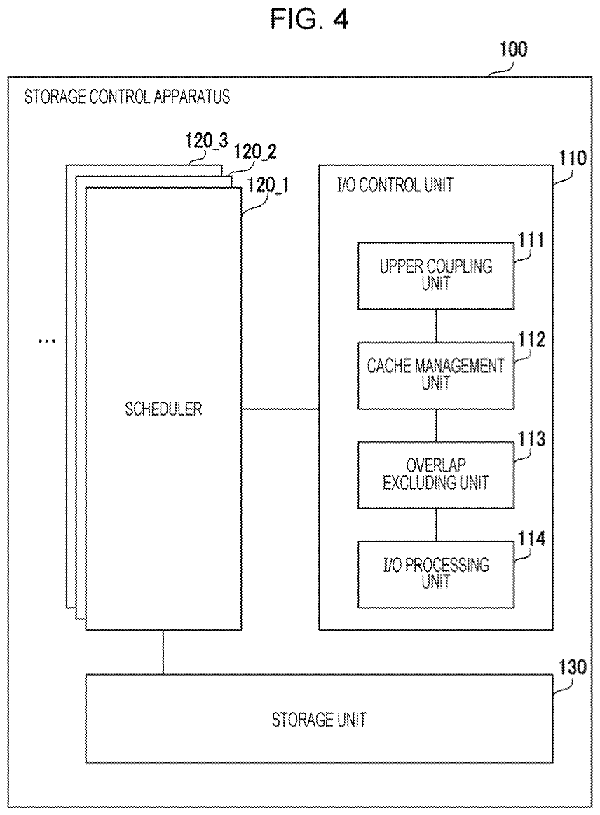

FIG. 4 is a block diagram illustrating a configuration example of processing functions that the storage control apparatus includes. FIG. 4 exemplarily illustrates a configuration of the storage control apparatus 100, but the storage control apparatus 200 also includes the same processing functions as those of the storage control apparatus 100.

The storage control apparatus 100 has an I/O control unit 110, schedulers 120_1, 120_2, 120_3, . . . and a storage unit 130. Processing in the 1/0 control unit 110 and the schedulers 120_1, 120_2, and 120_3, . . . are implemented by execution of predetermined programs by the CPU 101, for example. The storage unit 130 is implemented, for example, by a storage area of the RAM 102.

The I/O control unit 110 controls I/O processing on a logical volume in response to an I/O request from the host server 50. The I/O control unit 110 has, for example, an upper coupling unit 111, a cache management unit 112, an overlap excluding unit 113, and an I/O processing unit 114.

The upper coupling unit 111 receives an I/O request (write request or read request) from the host server 50. The cache management unit 112 controls the I/O processing according to an I/O request received by the upper coupling unit 111 by using a cache area provided in the RAM 102. The overlap excluding unit 113 performs a control for excluding an overlap of data to be stored in the storage 300 in response to an I/O request. The I/O processing unit 114 writes data from which an overlap is excluded in the storage 300. In this case, the writing is controlled by redundant arrays of inexpensive disks (RAID), for example. The I/O processing unit 114 reads out data from the storage 300.

The schedulers 120_1 ,120_2, 120_3, . . . control execution of tasks occurring in the units of the I/O control unit 110. Tasks in the I/O control unit 110 are substantially executed by the schedulers 120_1, 120_2, 120_3 . . . . The processing in the schedulers 120_1, 120_2, 120_3, . . . is executed by separate cores included in the CPU 101. When new tasks occur as a result of the execution of the tasks, the schedulers 120_1, 120_2, 120_3, . . . distribute the new tasks to the cores for execution such that the processing load may be distributed among the cores in the CPU 101.

For example, the storage unit 130 stores various kinds of data to be used for execution of the task distribution control on the cores by the schedulers 120_1, 120_2, 120_3, . . . .

Next, the task distribution control on the cores will be described. Hereinafter, though processing in the storage control apparatus 100 will be described, the same processing is also executed in the storage control apparatus 200.

In order to increase the processing performance of a multicore system, it is important to evenly increase the usage rates (CPU busy rates) of all cores by distributing processing loads among the cores. The storage control apparatus 100 levels the usage rates of the cores by fragmenting an I/O process in the I/O control unit 110, breaking down the result of the fragmentation into tasks as units, and distributing the tasks such that the cores evenly execute the tasks. Thus, the I/O processing performance is improved. Methods for distributing loads among cores include a dynamic load distribution and a static load distribution. Because the storage control does not allow grasping of the processing state of the host server 50 that issues an I/O request, it is difficult to use the static load distribution. Therefore, the dynamic load distribution is used,

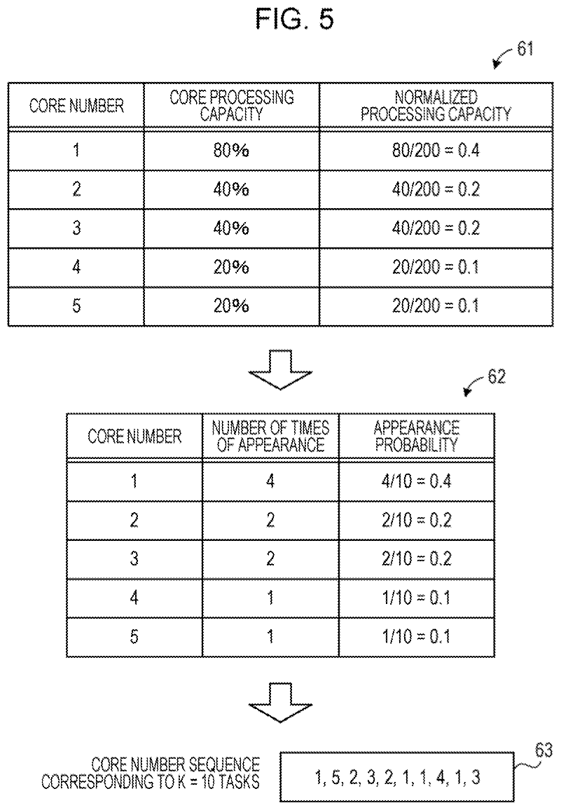

FIG. 5 is a diagram for explaining task distribution control based on ration of processing capacities of cores. According to this embodiment, the schedulers 120_1, 120_2, 120_3, . . . collect processing capacities of the cores and distribute tasks to the cores by the probability based on the ration of the processing capacities. The term “processing capacity” refers to a reserve capacity of a core, which is acquired by, for example, subtracting the usage rate (busy rate) of the core from 100%.

As an example, the CPU 101 in the storage control apparatus 100 includes five cores. Hereinafter, a core with a core number x may be written as “core #x”. As illustrated in Table 61 in FIG. 5, it is assumed that the cores #1 #2, #3, #4, and #5 have processing capacities of 80%, 40%, 40%, 20%, and 20%, respectively. In this case, normalizing the processing capacities such that the total is equal to 1, the normalized processing capacities of the cores #1, #2, #3, #4, and #5 are 0.4, 0.2, 0.2, 0.1, and 0.1, respectively. In order to level the load balance, more tasks are to be distributed to a core having a larger processing capacity (reserve capacity). Therefore, the normalized values indicate a distribution probability of tasks to the cores.

A case will be considered in which K tasks are to be distributed. K is an arbitrary integer equal to or higher than 1. The number of times of appearance in Table 62 is a number indicating how many times each of cores appears as a distribution destination for K=10 tasks. The appearance probability for appearance of a core agrees with the task distribution probability.

In other words, for example, among 10 tasks, the numbers of tasks to be distributed to the cores #1, #2, #3, #4, and #5 are 4, 2, 2, 1, and 1, respectively.

The 10-digit core number sequence 63 illustrated in FIG. 5 is a number sequence including the core numbers of the cores appearing the number of times equal to the number of times of appearance in Table 62. In this number sequence, the core numbers are arranged in randomly shuffled order. By determining the distribution destination cores of tasks based on the core number sequence 63, the tasks are distributed to the cores by the probability based on the ration of the processing capacities among the cores. In other words, for example, each of the schedulers 120_1, 120_2, 120_3, . . . determines the order of distribution for cores as indicated by the core number sequence 63 based on the processing capacities collected from the cores so that the load balance among the cores may be optimized in accordance with changes of the load balance.

Each of the cores, that is, each of the schedulers 120_1, 120_2, 120_3, . . . collects processing capacities of the cores for N tasks generated newly by the execution of tasks by the core and updates the distribution probability to the cores based on the processing capacities. Each of the schedulers 120_1, 120_2, 120_3, . . . determines the distribution destinations of the N tasks based on the updated distribution probability.

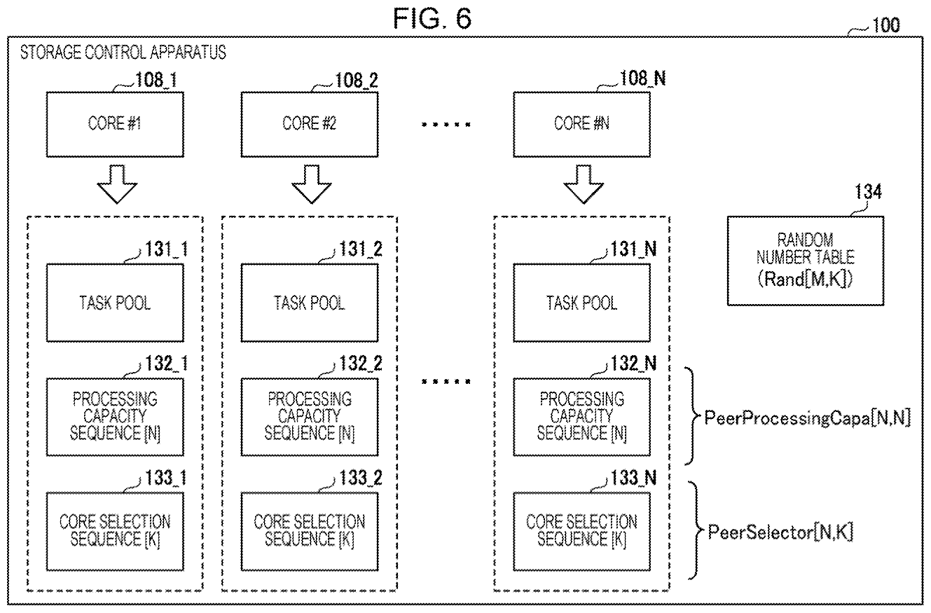

FIG. 6 is a diagram illustrating are example of information to be used for task distribution control. Hereinafter, it is assumed that the storage control apparatus 100 includes N cores 108_1 to 108_N. The cores 108_1 to 108_N are examples of the processing units 2a to 2c illustrated in FIG. 1. Hereinafter, the cores 108_1, 108_2, 108_N may be written as cores #1, #2, . . . , #N. N is an arbitrary integer equal to or higher than 2.

The storage unit 130 stores a task pool, an N-digit (one row and N columns) processing capacity sequence and a K-digit (one row and K columns) core selection sequence, which are used by each of the core 108_1 to 108_N. For example, a task pool 131_1, a processing capacity sequence 132_1, and a core selection sequence 133_1 are used by the core 108_1. A task pool 131_2, a processing capacity sequence 132_2, and a core selection sequence 133_2 are used by the core 108_2. A task pool 131_N, a processing capacity sequence 132_N, and a core selection sequence 133_N are used by the N-th core 108_N.

The task pools 131_1 to 131_N are First-in/First-out (FIFO) queues storing tasks distributed to the corresponding cores. The core (or the scheduler operated by the core; sequentially obtains tasks from the task pool and executes the obtained tasks.

Each of the processing capacity sequences 132_1 to 132_N is a number sequence including elements corresponding to each of the cores 108_1 to 108_N. Each of the elements included in each of the processing capacity sequences 132_1 to 132_N stores a numerical value indicating the processing capacity collected from the corresponding core.

Each of the core selection sequences 133_1 to 133_N is a number sequence including elements corresponding to each of K tasks. Each of the elements included in each of the core selection sequences 133_1 to 133_N stores a core number indicating a core that is a distribution destination of the corresponding task.

The matrix PeerProcessingCapa illustrated in FIG. 6 is an N-row and N-column matrix including the processing capacity sequences 132_1 to 132_N as rows. Hereinafter, the N-row and N-column matrix PeerProcessingCapa may be written as PeerProcessingCapa[N,N].

The matrix PeerSelector illustrated in FIG. 6 is an N-row and K-column matrix including the core selection sequences 133_1 to 133_N as rows. Hereinafter, the N-row and K-column matrix PeerSelector may be written as PeerSelector[N,K].

The storage unit 130 stores a random number table 134. The random number table 134 is implemented as an M-row and K-column matrix Rand, and each row has a random number equal to or lower than K. Hereinafter, the M-row and K-column matrix Rand may be written as Rand[M,K]. The random number table 134 (matrix Rand) is shared by the cores 108_1, 108_2, . . . 108_N (or the schedulers 120_1, 120_2, 120_3 . . . ).

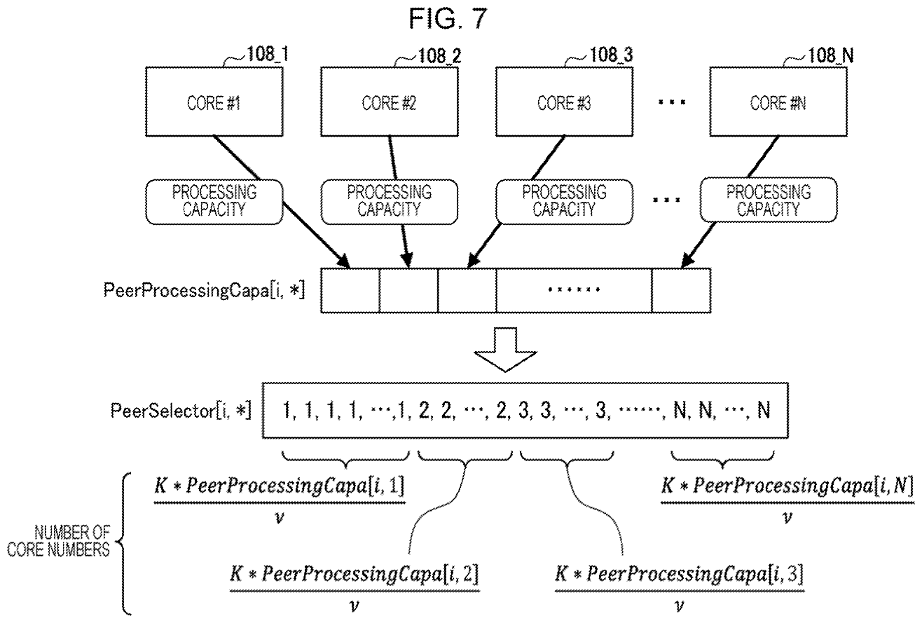

Task distribution control by using the sequences and the random number table 134 will be described below. Processing in a scheduler operating in the i-th core 108_i (core #i) among the schedulers 120_1 120_2, 120_3, . . . , will be described below with reference to FIGS. 7 to 12.

FIG. 7 is a diagram for explaining processing of generating a sequence.

After completing distribution of N tasks, the scheduler collects current processing capacities from the core #1 to #N (core 108_1 to 1 _N) when next new tasks occur. The scheduler stores numerical values of the processing capacities collected from the corresponding cores to elements in PeerProcessingCapa[i,*]. The “*” in the brackets indicates that no numerical value is specified. PeerProcessingCapa[i,*] indicates the i-th row in the matrix PeerProcessingCapa and corresponds to the processing capacity sequence to be used for task distribution control by the core #i.

Next, the scheduler generates PeerSelector[i,*] based on PeerProcessingCapa[i,*]. PeerSelector[i,*] indicates the i-th row in the matrix PeerSelector and corresponds to the co selection sequence to be use for task distribution control by the core #i.

PeerSelector[i,*] stores core numbers indicating the cores #1 to #N the number of which is based on the ration of the processing capacities. In other words, for example, the number of core numbers to be stored in the PeerSelector[i,*] indicates the number of tasks to be distributed to cores indicated by the core numbers among K tasks (the number of distributed tasks to K tasks).

The scheduler first calculates a total value v of the elements in the PeerProcessingCapa[i,*] by using the following Expression (1).

$$v = {\sum }_{j = 1}^{N} PeerProcessingCapa [ i , j ] \qquad ( 1 )$$

Next, as illustrated in FIG. 7, the scheduler determines the number of the core number of the j-th core #j (the number of tasks to be distributed to the core #j) to be stored in PeerSelector[i,*] by using K*PeerProcessingCapa[i,l]/v. For example, the number of tasks to be distributed to the core #1 is determined by using K*PeerProcessingCapa[i,1]/v. However, the calculation of the number of tasks to be distributed by using the expression may result in a decimal value. Accordingly, more specifically, for example, the number of tasks to be distributed is determined as follows.

First, pⱼ is calculated by the following Expression (2).

pⱼ=PeerProcessingCapa[i,j]/v (2)

Next, based on Expression (2), the numbers of tasks to be distributed S₁, S₂, and S₃ for the cores #1 , #2 , #3 are calculated by the following Expressions (3-1), (3-2), and (3-3).

S₁=Round(K×p₁) (3-1)

S₂=Round (K×(p₁+p₂))−S₁ (3-2)

S₃=Round(K×(p₁+p₂+p₃))−(S₁+S₂) (3-3)

Putting the Expressions (2), (3-1), (3-2), and (3-3) together, the number Sⱼ of tasks to be distributed to the core #j is calculated by the following Expression (4). ROUND(X) indicates a value acquired by dropping the fractional portion of X.

$${S}_{j} = ROUND ( K * {\sum }_{n = 1}^{j} {p}_{t} ) - {\sum }_{m = 1}^{j - 1} {S}_{u} \qquad ( 4 )$$

By using Expression (4) above, the number of tasks to be distributed to the cores are determined by performing the calculation on the beginning to the end of the core numbers once. Even when a calculation error occurs because of the dropping of the fractional part between the number of tasks to be distributed based on Expression (2) and the number of tasks to be distributed based on Expression (4) it is assured that the total sum of the number of tasks to be distributed by Expression (4) is equal to K.

After generating PeerSelector[i,*] by performing the steps above, the scheduler next randomly selects a column number in PeerSelector[i,*] for each of the K tasks and determines, as a task distribution destination, the core indicated by the core number stored as an element of the selected column number. Thus, by randomly obtaining a core number from PeerSelector[i,*] (core selection sequence), a sequence corresponding to the core number sequence 63 illustrated in FIG. 5 is obtained. In other words, for example, the distribution destinations of K tasks are determined by the distribution probability based on the ration of the processing capacities of the cores.

The randomness of the element selection from PeerSelector[i,*] has an influence on the randomness of the task distribution, and the precision of the leveling of loads among cores is influenced as a result. For random selection of an element from PeerSelector[i,*], random numbers equal to or lower than K may be acquired by calculations, for example. In other words, for example, each of numerical values included in the calculated random number sequence is used as a column number indicating the element to be selected. However, the load of the random number calculation processing in this method is problematic.

The processing load for task distribution control is desirably light because the processing load has an adverse effect on the processing performance of the system, especially, on the I/O processing performance. The random number calculation processing as described above in the processing included in the task distribution control is relatively high load processing. An increase of the execution frequency of the random number calculation processing has a large influence on the I/O processing performance. Accordingly, the execution frequency of the random number calculation processing is desirably reduced. However, on the other hand, high randomness is required for the generated random numbers.

As another random number generation method, a method using a pre-stored random number table is used, without relying on the calculations. This method does not impose the calculation load for the random number generation but requires some device for increasing the randomness. For example, a plurality of random number sequences are prepared for K elements (one row and K columns), and random numbers are acquired by using different random number sequences for each set of K tasks. However, this method requires many random number sequences for higher randomness, and the size of the storage area for storing the random number sequences increases. When random number sequences are selected under a predetermined rule such as selecting random number sequences in order, regularity occurs in the random numbers as a whole, which is problematic in view of randomness.

Accordingly, this embodiment uses both, of the random number calculations and the random number table 134 (Rand[M,K]) having a plurality of (M rows) random number sequences so that the calculation loads and the size of the storage area of the random number table 134 may be suppressed and the randomness of the obtained random numbers may be improved. More specifically, when distribution control on K tasks is started, a numerical value having a value equal to or lower than K is obtained randomly by the random number calculation, and a row is selected from the random number table 134 based on the numerical value. By selecting a numerical value one by one from the random number sequence of the selected row, a column number in PeerSelector[i,*] is selected one by one, and the distribution destinations of the K tasks are determined.

According to this method, in order to distribute K tasks, one numerical value having a value equal to or lower than K is calculated by the random number calculation. In other words, for example, a one row and K column random number sequence is calculated only once for distributing K*K tasks. Therefore, compared with the case where each of numerical values included in the calculated random number sequence is used as a column number indicating an element to be selected from PeerSelector[i,*], the number of calculations of random number sequences may be reduced. As a result, the processing load for task distribution control may be reduced. The calculated random number sequence is used to select a random number sequence to be used from M-row random number sequence. Thus, compared with the case where a random number sequence to be used is selected under a predetermined rule from M-row random number sequence, the randomness of element selection from PeerSelector[i,*] may be improved.

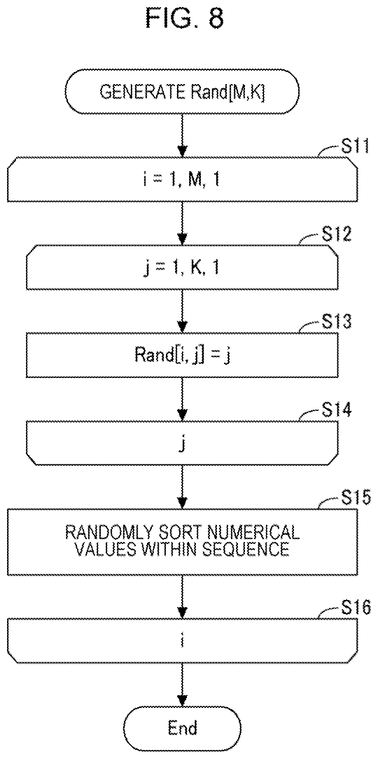

Next, processes relating to task distribution control in the storage control apparatus 100 will be described with reference to flowcharts. First, a process for generating the random number table 134 (Rand[M,K]) in advance will be described with reference to FIG. 8.

FIG. 8 is an example of a flowchart illustrating a process of generating the random number table. The process in FIG. 8 is executed before task distribution control is started. For example, when the storage control apparatus 100 is started or when the I/O control unit 110 is started, the processing in FIG. 8 is executed. Execution of the process in FIG. 8 results in generation of the random number table 134 (Rand[M,K]).

The process in FIG. 8 may be executed any one of the schedulers 120_1, 120_2, 120_3 . . . . As an example, it is assumed that the scheduler 120_1 executes the process in FIG. 8.

[Step S11] The scheduler 120_1 repeatedly executes processing up to step 816 by increasing the value of a variable i by one from 1 to M. The variable i indicates a row number in Rand[M,K].

[Step S12] The scheduler 120_1 repeatedly executes process ng to step S14 by increasing the value of a variable j by one from 1 to K. The variable j indicates a column number in Rand[M,K].

[Step S13] The scheduler 120_1 sets the value of j in Rand[i,j] (an element at the i-th row and j-th column in the random number table 134).

[Step S14] When the variable j reaches K, the processing moves to step S15. In this condition, integers from 1 to M are sequentially arranged in Rand [i,*] (the i-th row in the random number table 134).

[Step S15] The scheduler 120_1 randomly sorts the numerical values within the sequence of Rand [i,*]. This sorting is executed by using, for example, Fisher-Yates shuffle algorithm.

[Step S16] When the variable i reaches M, the processing ends.

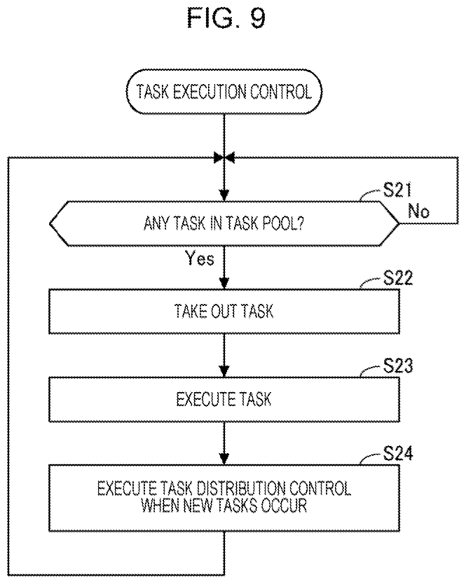

FIG. 9 is an example of a flowchart illustrating a task execution control process. The process in FIG. 9 is independently executed by the schedulers 120_1, 120_2, 120_3, . . . corresponding to the core #1 to #N (dares 108_1 to 108_N). As an example, the process by the scheduler 120_i corresponding to the i-th core #o (core 108_i) will be described.

[Step S21] The scheduler 120_i determines tasks are registered with the task pool 131_i. If tasks are registered, the scheduler 120_i executes processing in step S22. If not, the scheduler 120_i executes the processing in step S21 again after a predetermined period of time.

[Step S22] The scheduler 120_i takes out one task from the task pool 131_i.

[Step S23] The scheduler 120_i executes the taken task. Thus, a fragmentary process of the I/O control unit 110 is executed by the core #i.

[Step S24] When new tasks occur because of the execution of the task in step'S23, the scheduler 120_i executes the task distribution control to distribute the new tasks to the core #1 to core N. After the task distribution control completes, the scheduler 120_i executes the processing in step S21. On the other hand, if new tasks do not occur, the scheduler 120_i directly executes the processing in step S21.

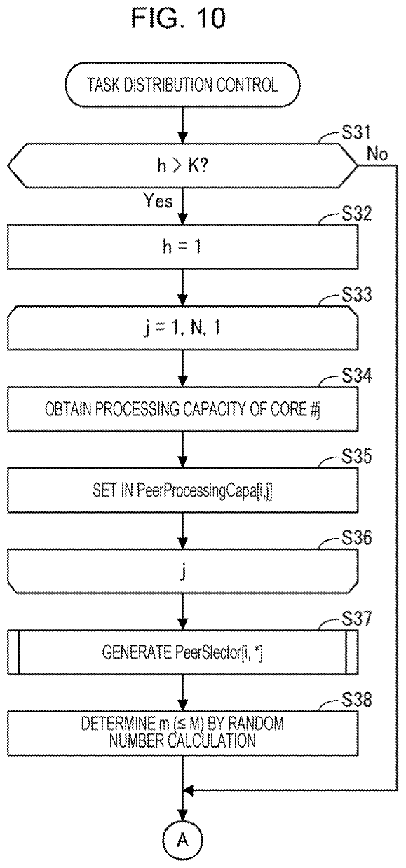

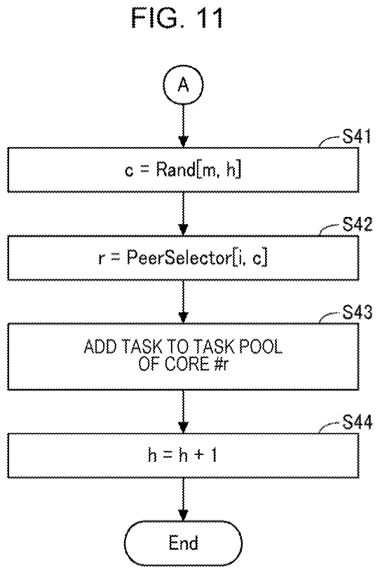

FIGS. 10 and 11 are an example of a flowchart illustrating the task distribution control process. When new tasks occur in step S24 in FIG. 9, the processing in FIG. 10 is executed on the tasks as processing targets.

[Step S31] The scheduler 120_i determines whether a variable h is higher than K. If the variable h is higher than K, the scheduler 120_i executes processing in step S32. If the variable h is equal to or lower than K, the scheduler 120_i executes processing in step S41 in FIG. 11. The variable h has an initial value that is an arbitrary integer higher than K.

[Step S32] The scheduler 120_i sets the variable h to 1.

[Step S33] The scheduler 120_1 repeatedly executes processing up to step S36 by increasing the value of the variable j by one from 1 to N. The variable j indicates a column number in Rand[M,K].

[Step S34] The scheduler 120_i obtains the current'processing capacity of the j-th core #j.

[Step S35] The scheduler 120_i sets the value of the processing capacity obtained in step S34 at PeerProcessingCapa[i,j] (the element at the i-th row and j-th column in the matrix PeerProcessingCapa).

[Step S36] When the variable j reaches N, the processing moves to step S37. In this case, PeerProcessingCapa[i,*] (the i-th row in the matrix PeerProcessingCapa) has an updated state.

[Step S37] The scheduler 120_i executes processing of generating PeerSelector[i,*] (the i-th row in the matrix PeerSelector).

[Step S38] The scheduler 120_i calculates an integer equal to or lower than by the random number calculation and determines the value as the variable m.

Hereinafter, the description continues with reference to FIG. 11.

[Step S41] The scheduler 120_i reads out Rand[m,h] (numerical value at the m-th row and hth column in the random number table 134) and sets the read value to the variable c.

[Step S42] The scheduler 120_i reads out PeerSelector[i(c] (numerical value at the i-th row and c-th column in the matrix PeerSelector and sets the read value to the variable r.

[Step S43] The scheduler 120_i adds a task to the task pool 131_r corresponding to the r-th core #r.

[Step S44] The scheduler 120_i increases the variable h by 1.

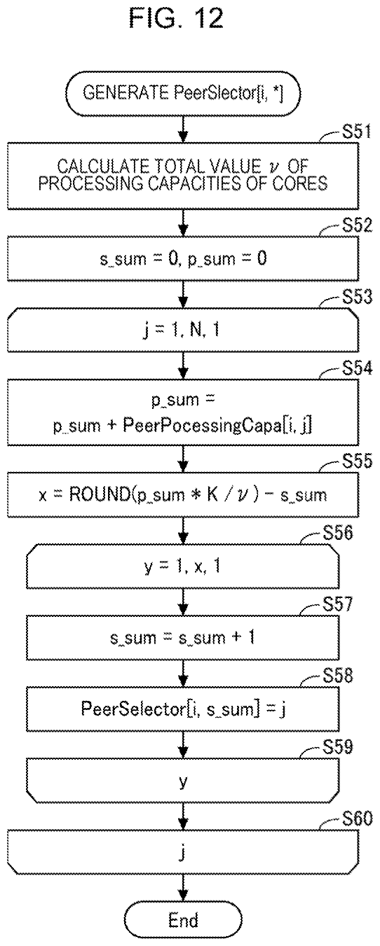

FIG. 12 is an example of a flowchart illustrating a process of generating PeerSelector[i,*]. The process in FIG. 12 is processing to be executed in step S37 in FIG. 10.

[Step S51] The scheduler 120_i calculates a total value v of the processing capacities obtained from the cores #1 to #N in step S34 in FIG. 10 (total value of the elements in PeerProcessingCapa[i,*] by using Expression (1).

[Step S52] The scheduler 120_i resets both of the variables s_sum and p_sum to zero.

[Step S53] The scheduler 120_i repeatedly executes processing up to step S60 by increasing the value of the variable j by one from 1 to N. The variable j indicates a column number in the PeerProcessingCapa[i,*].

[Step S54] The scheduler 120_i adds the value of PeerProcessingCapa[i,j] (value at the i-th row and j-th column in the matrix PeerProcessingCapa) to the variable p_sum and updates the variable p_sum.

[Step S55] The scheduler 120_i calculates a variable x by using the following Expression (5). The variable x indicates the number of tasks to be distributed to the j-th core #j.

x=ROUND(p_sum*K/v)−s_sum (5)

[Step S56] The scheduler 120_i repeatedly executes processing up to step S59 by increasing the value of a variable y by one from 1 to x. The variable y is used for controlling the number of times of execution of the loop.

[Step S57] The scheduler 120_i adds 1 to the variable s_sum and updates the variable s_sum.

[Step S58] The scheduler 120_i sets the variable j to PeerSelector[i,s_sum] (element at the i-th row and s_sumth column in the matrix PeerSelector)

[Step S59] When the variable y reaches x, the processing of setting x core numbers j to PeerSelector[i,*] completes, and the processing moves to step S60.

[Step S60] When the variable j reaches N, the processing of setting core numbers to all elements in PeerSelector[i,*] completes, and the process in FIG. 12 ends.

In the processes in FIGS. 8 to 12 as described above, when a task at the beginning of K tasks occurs, the current processing capacities of the cores #1 to #N are collected. The core numbers of the core #1 to #N to which tasks are to be distributed are set to PeerSelector[i,*] where the number of the core numbers to be set is based on the ration of the collected processing capacities. The core numbers set to the PeerSelector[i,*] are randomly selected so that the cores indicated by the selected core numbers are determined as the distribution destinations of the tasks. By performing this processing, K tasks may be distributed to the cores #1 to #N by the distribution probability based on the ration of the processing capacities of the cores #1 to #N.

In order to randomly select the core numbers set in PeerSelector[i,*], the selection processing is performed by using both of the random number calculation and the random number table 134. In this processing, in order to distribute K tasks, a random numerical value equal to or lower than the number of rows (M) of the random number table 134 is calculated once by the random number calculation, and a random number sequence at the row of the calculated numerical value is selected from the random number table 134. Then, the selected random number sequence is used to randomly select core numbers. This reduces the processing load of the random number calculation so that the influence of the processing load on the storage control performance by the I/O control unit 110 may be reduced. As a result, the storage control performance by the I/O control unit 110 may be improved. Because the processing load of the random number calculation is reduced and at the same time the randomness of the selection of core numbers may be improved as described above, the precision of the load distribution in the cores #1 to #N may be increased.

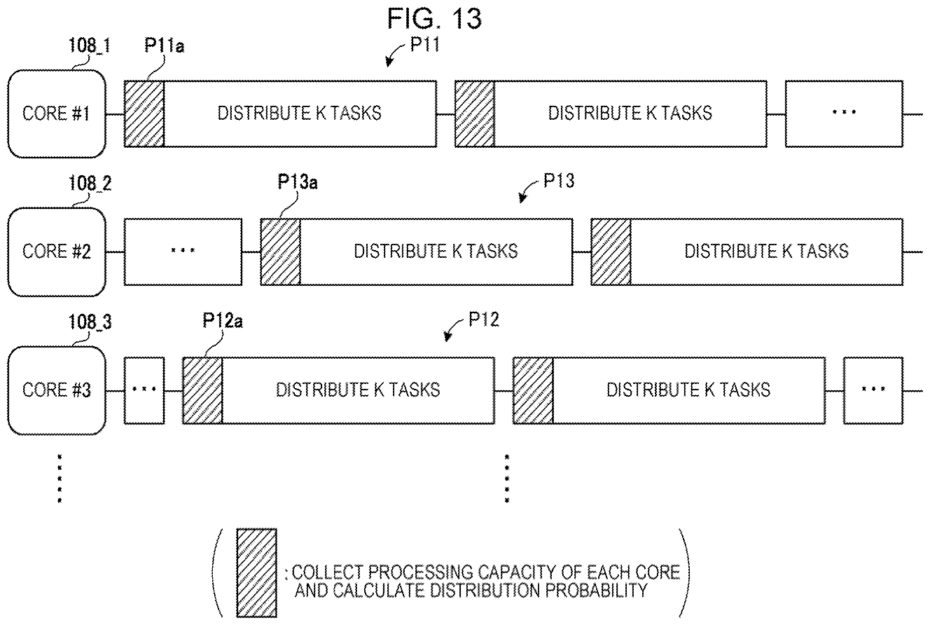

The distribution control for a set of K tasks as described above is performed independently in each of the cores #1 to #N. As a result, as illustrated in FIG. 13, the load distribution may be implemented with high precision even when the load balance changes in the cores #1 to #N.

FIG. 13 is a diagram schematically illustrating how task distribution control is performed in cores. As described above, the distribution control on K tasks to be executed in each of the cores #1 to #N includes the processing of collecting processing capacities of the cores #1 to #N and generating PeerSelector[i,*] and processing of distributing the K tasks by using PeerSelector[i,*]. The former processing between them corresponds to calculation of a distribution probability of tasks to the cores #1 to #N based on the collected processing capacities.

In this way, the control of distribution of K tasks is executed by the distribution probability based on processing capacities collected at the beginning of the period when the K tasks occur. In other words, for example, one distribution probability calculated at the beginning of the period when K tasks occur is used to perform the distribution control. For that, even when the load balance changes among the cores within a period when K tasks occur, a new distribution probability is not calculated until the period ends. Therefore, in a case where the load balance among cores is leveled by performing the procedure above in one of the cores #1 to #N, for example, and when the load balance changes among the cores within the period when K tasks occur, the precision of the leveling of the load balance decreases.

On the other hand, according to this embodiment, as illustrated in FIG. 13, the distribution control over K tasks as described above is independently executed by each of the cores #1 to #N. Because the second and subsequent tasks of the K tasks are newly generated with execution of the task obtained from the task pool, the time for the distribution control over the K tasks depends on processing details of the task obtained from the task pool. For that, the stages of progress of the distribution control over the K tasks differ among the cores #1 to #N. As a result, the times when each of the cores #1 to #N collects the processing capacities from the cores #1 to #N and calculates the distribution probability are dispersed.

In other words, for example, in the middle of the period when one core calculates a distribution probability and distributes K tasks, another core calculates the distribution probability again and distributes other K tasks based on the distribution probability. For example, referring to FIG. 13, in the execution period of a distribution control P11 over K tasks after the core #1 starts the distribution control P11, the core #3 starts a distribution control 112 over K tasks, and the core #2 starts a distribution control P13 over K tasks. Thus, after a distribution probability calculation process 11a is executed upon start of the distribution control P11, the distribution probability calculation processes P12a and P13a are executed during the period of execution of the distribution control P11.

In this way, the distribution control over K tasks is executed independently in each of the cores #1 to #N so that the frequency of calculation of the distribution probability based on the result of collection of the processing capacities is increased. Because of the execution of the task distribution control based on the distribution probability calculated at a high frequency, tasks are distributed to proper distribution destinations by rapidly following changes of the load balance among the cores. Therefore, the precision of the load distribution may be improved.

Next, variation examples acquired by changing parts of processing according to the second Embodiment will be described. First, Variation Examples 1 and 2 regarding the method for generating a random numerical value equal to or lower than M by using the random number table 134 will be described.

### Variation Example 1

According to the second Embodiment, the random variable m equal to or lower than M is generated by the random number calculation in step S38 in FIG. 10. In steps S41 to S43 in FIG. 11, a random number sequence at the m-th row is selected from the random number table 134, and a numerical value is read one by one from the beginning of the selected random number sequence to determine the distribution destinations of tasks. On the other hand, according to Variation Example 1, a random variation n equal to or lower than K is further generated by the random number calculation. A random number sequence at the moth row is selected from the random number table 134, and a numerical value is cyclically read from the random number sequence by defining the numerical value at the nth column of the selected random number sequence as the beginning to determine the distribution destinations of tasks.

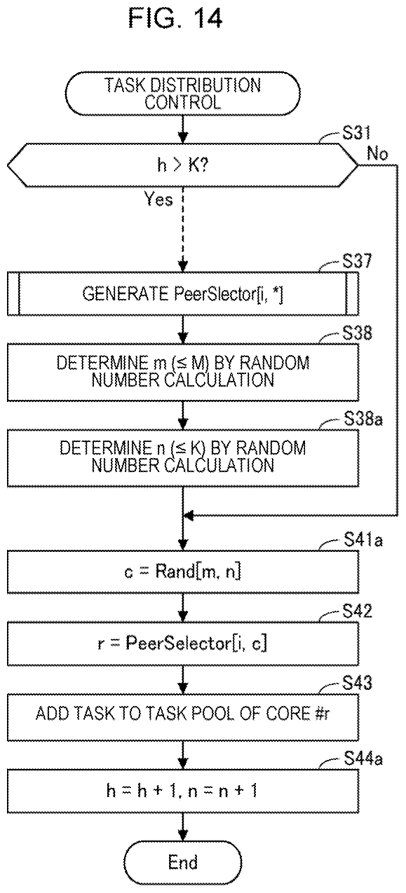

FIG. 14 is an example of a flowchart illustrating task distribution control processing according to Variation Example 1. Like step numbers refer to like processing details in FIG. 14 and FIGS. 10 and 11, and repetitive description will be omitted.

In the processing in FIG. 14, processing in step S38a is executed after the variable m is determined in step S38 in FIG. 10. In Step S38a, the scheduler 120_i calculates an integer equal to or lower than K by the random number calculation and determines the value as the variable n. Step S38a may be executed before step S38.

Steps S41a and S44a are executed instead of steps S41 and S44 in FIG. 11, respectively. In Step S41a, the scheduler 120_i reads out Rand[m,n] (numerical value at the m-th row and n-th column in the random number table 134) and sets the read value to the variable c. In step S44a, the scheduler 120_i increases the variable h by 1 and also increases the variable n by 1.

By performing this processing, a different random number sequence is generated with the use of the random variable n even if the same random number sequence is selected from the random number table 134 for distribution control over K tasks. Thus, compared with the second Embodiment, the randomness for selecting cores as task distribution destinations may be improved. Compared with the second Embodiment, when the number M of rows of the random number table 134 is reduced, the same level of randomness as that of Second Embodiment may be acquired. In this case, the storage capacity of the random number table 134 may be reduced.

### Variation Example 2

According to Variation Example 2, two variables m1 and m2, instead of one variable m, are generated by the random number calculation as random numerical values equal to or lower than M. After the random number sequence at the mist row is selected from the random number table 134, the number of columns at the beginning for reading a numerical value from the random number sequence is determined by using the random number sequence at the m2nd random number sequence.

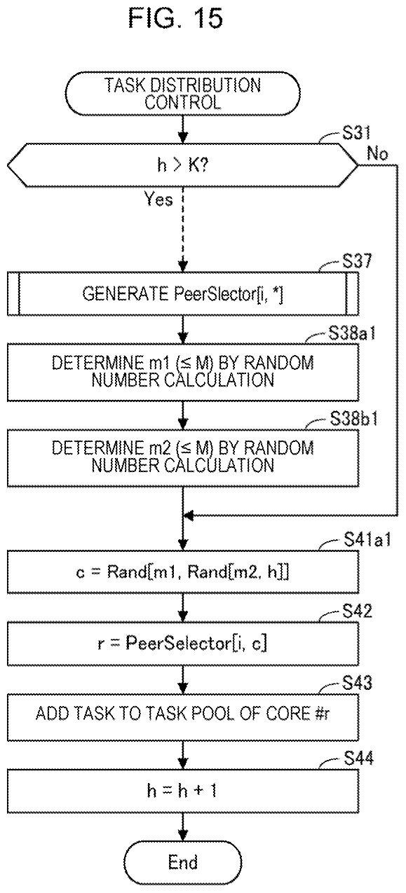

FIG. 15 is an example of a flowchart illustrating task distribution control processing according to Variation Example 2. Like step numbers refer to like processing details in FIG. 15 and FIGS. 10 and 11 and repetitive descriptions will be omitted.

In the processing in FIG. 15, steps S38a1 and S38b1 are executed instead of step S38 in FIG. 10. Steps S41a1 is executed instead of steps S41 in FIG. 11.

In Step S38a1 the scheduler 120_i calculates an integer equal to or lower than M by the random number calculation and determines the value as the variable m1. In Step S38a2, the scheduler 120_i calculates an integer equal to or lower than by the random number calculation and determines the value as the variable m2. In Step S41a1 the scheduler 120_i reads out Rand[m1,Rand[m2,h]] and sets the read value to the variable c. In step S41a1, the random number sequence at the mist row is selected from the random number table 134. The numerical value at the m2nd row and hth column in the random number table 134 is read out as the number of columns in the selected random number sequence.

By performing this processing, even if the same random number sequence is used from the random number table 134 for distribution control over K tasks, the number of columns at the beginning for selecting a numerical value cyclically from the random number sequence is determined based on another random number sequence. Thus, compared with the second Embodiment and Variation Example 1 thereof, the randomness for selecting cores as task distribution destinations may be improved. Compared with the second embodiment and Variation Example 1, when the number M of rows of the random number table 134 is reduced, the storage capacity of the random number table 134 may be reduced without reducing the randomness.

The second embodiment and Variation Examples 1 and 2 are common in that a random numerical value equal to or lower than M is calculated by the random number calculation, and the random number sequence at the row of the calculated numerical value is selected from the random number table 134 for use in task distribution control. This processing is characterized in that the amount of computational complexity for the random number does not change even when the magnitude of K changes. There is also a characteristic that substantially equal randomness may be acquired independently from M and K because K increases as decreases when the capacity of the entire random number table 134 is predetermined though the randomness of task distribution increases as M increases.

Because randomnesses of the sequence in the column direction and the sequence in the row direction are equivalent because M is the factorial of K. As a result, the randomness as a whole may be improved. This case is equivalent to expansion of the number of rows in the random number table 134 K times according to Variation Example 1 and is equivalent to expansion of the number of columns M times according to Variation Example 2.

According to Variation Example 1, the variable n may be calculated without calculating the variable m. In this case, the number M of rows of the random number table 134 may be equal to one. In this case, the randomness of the selected numerical value may be increased, compared with a case where a numerical value is selected one by one from the beginning of the random number sequence of one row.

### Variation Example 3

Processing for storage control (processing by the I/O control unit 110) includes, for example, a process requiring immediate response performance, a process requiring parallel processes using a plurality of cores at the same time, and a process requiring limitation of an influence of abnormality of processing such as an endless loop. These processes are desirably executed by special cores different from those of other types of processing.

According to Variation Example 3, a process execution function is defined for each type of process. For example, a special function for executing a specific type of process and a generic function for generically executing types of process other than the specific type of process are defined. The cores included in the CPU 101 are divided into one or more core sets for implementing the special function and one or more core sets for implementing the generic function.

According to Variation Example 3, the distribution control over K tasks is executed for each core set. When a task to be executed in another core set is generated in a core belonging to one core set, the task is distributed to the core belonging to the other core set. In this case, the distribution control over K tasks is performed on the other core set such that loads may be distributed among cores in the other core set.

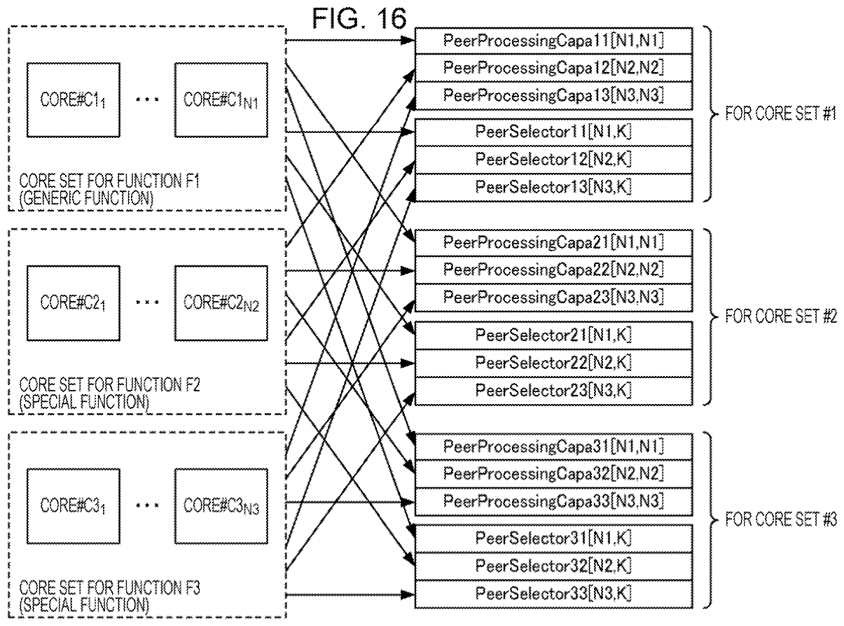

FIG. 16 is a diagram illustrating a configuration example of function-based cores and matrices to be used. As an example in FIG. 16, the cores included in the CPU 101 are divided into core sets #1, #2, and #3. The core set #1 is a set of cores implementing a function F1. The core set #2 is a set of cores implementing a function F. The core set #3 is a set of cores implementing a function F3. The function F2 is a special function that executes a specific first type of processing. The function F3 is another special function that executes a specific second type of processing. The function F1 is a generic function that generically executes another type of processing that is different from the first and second types. The core set #1 includes N1 cores #C1₁ to #C1_{N1}. The core set #2 includes N2 cores #C21 to #C2_{N2}. The core set #3 includes N3 cores #C3₁ to #C3_{N3}.

The cores belonging to the core set #1 perform the task distribution control and distribute tasks to the cores #C11 to #C1_{N1} such that the load balance is leveled among the cores #C1₁ to #C1_{N1} within the core #1 for K tasks of the type corresponding to the function F1. For the distribution control, the cores #C1₁ to #C1_{N1} use PeerProcessingCapa11[N1,N1] and PeerSelector11[N1,K]. For example, the i-th core belonging to the core set #1 collects processing capacities from the cores #C1ᵢ to #C1_{N1} and generates PeerProcessingCapa11[i,*] for distributing K tasks of the type corresponding to the function F1. The i-th core generates PeerSelector11[i,*] based on the generated PeerProcessingCapa11[i,*] and uses the generated PeerSelector11[i,*] to distribute the tasks to the cores #C1₁ to #C1_{N1}.

The cores belonging to the core set #1 perform the task distribution control and distribute tasks to the cores #C 2₁ to #C2_{N2} such that the load balance is leveled among the cores #C2₁ to #C 2_{N2} within the core #2 for K tasks of the type corresponding to the function F2. For the distribution control, the cores #C1₁ to #C1_{N1} use PeerProcessingCapa12[N2,N2]and PeerSelector12[N2,K]. For example, the i-th core belonging to the core set #1 collects processing capacities from the cores #C2₁ to #C2_{N2} and generates PeerProcessingCapa12[i,*] for distributing K tasks of the type corresponding to the function F2. The i-th core generates PeerSelector12[i,*] based on the generated PeerProcessingCapa12[i,*] and uses the generated PeerSelector12[i,*] to distribute the tasks to the cores #C2₁ to #C2_{N2}.

The cores belonging to the core set #1 perform the task distribution control and distribute tasks to the cores #C3₁ to #C3_{N3} such that the load balance is leveled among the cores #C3₁ to #C3_{N3} within the core #3 for K tasks of the type corresponding to the function F3. For the distribution control, the cores #C1₁ to #C1_{N1} use PeerProcessingCapa13[N3,N3] and PeerSelector13[N3,K]. For example, the i-th core belonging to the core set #1 collects processing capacities from the cores #C3₁ to #C3_{N3} and generates PeerProcessingCapa13[i,*] for distributing K tasks of the type corresponding to the function F3. The i-th core generates PeerSelector13[i,*] based on the generated PeerProcessingCapa13[i,*] and uses the generated PeerSelector13[i,*] to distribute the tasks to the cores #C3₁ to #C3_{N3}.

The same processing is performed in the cores belonging to the core sets #2 and #3. For example, the cores #C2₁ to #C2_{N2} belonging to the core set #2 use PeerProcessingCapa21[N1,N1] and PeerSelector21[N1,K] to distribute K tasks of the type corresponding to the function F1 to the cores #C1₁ to #C1_{N1}. The cores #C2₁ to #C2_{N2} belonging to the core set #2 use PeerProcessingCapa22[N2,N2] and PeerSelector22[N2,K] to distribute K tasks of the type corresponding to the function F2 to the cores #C2₁ to #C2_{N2}. The cores #C2₁ to #C2_{N2} belonging to the core set #2 use PeerProcessingCapa23[N3,N3] and PeerSelector23[N3,K] to distribute K tasks of the type corresponding to the function F3 to the cores #C3₁ to #C3_{N3}.

The cores #C3₁ to #C3_{N3} belonging to the core set #3 use PeerProcessingCapa31[N1,N1] and PeerSelector31[N1,K] to distribute K tasks, of the type corresponding to the function F1 to the cores #C1₁ to #C1_{N1}. The cores #C3₁ to #C3_{N3} belonging to the core set #3 use PeerProcessingCapa32[N2,N2] and PeerSelector32[N2,K] to distribute K tasks of the type corresponding to the function F2 to the cores #C2₁ to #C2 ₂. The cores #C3₁ to #C3_{N3} belonging to the core set #3 use PeerProcessingCapa33[N3,N3] and PeerSelector33[N3,K] to distribute K tasks of the type corresponding to the function F3 to the cores #C3₁ to #C3_{N3}.

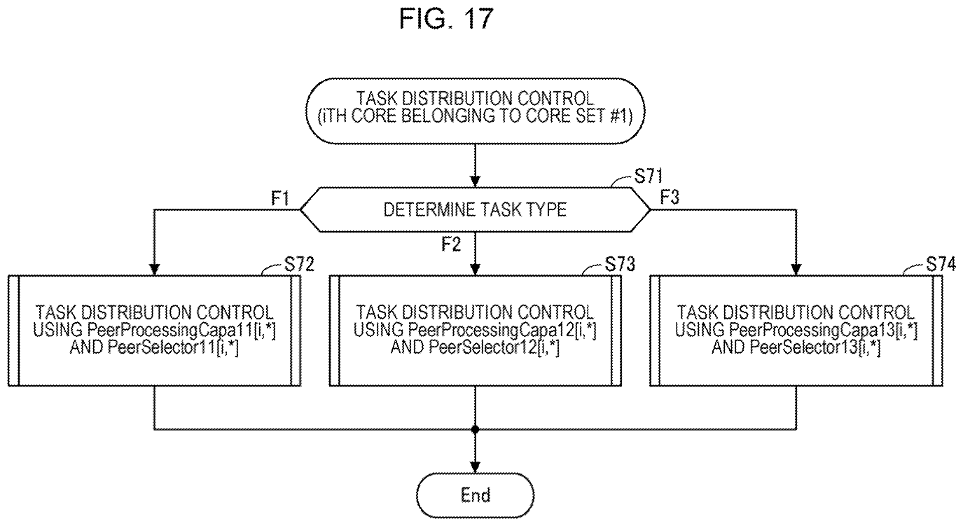

FIG. 17 is an example of a flowchart illustrating task distribution control processing according to Variation Example 3. The processing in FIG. 17 is executed instead of the processing in FIGS. 10 and 11. As an example, the process by the scheduler corresponding to the i-th core belonging to the core set #1 will be described.

[Step S71] The scheduler determines the type of tasks that have newly occur. For example, information on the occurring tasks contain information indicating the type of the tasks. When the type of tasks corresponds to the function F1, the scheduler executes processing in step S72. When the type of tasks corresponds to the function F2, the scheduler executes processing in step S73. When the type of tasks corresponds to the function F3, the scheduler executes processing in step S74.

[Step S72] The scheduler executes task distribution control to the cores #C1₁ to #C1_{N1} belonging to the core set #1 by performing the same procedure as that in the processing in FIGS. 10 and 11. In this case, PeerProcessingCapa11[i,*] and PeerSelector11[i,*] are used. In the task distribution control, the scheduler collects the processing capacities from the cores #C1₁ to #C1_{N1} and generates PeerProcessingCapa11[i,*]. The scheduler generates PeerSelector11[i,*] based on the generated PeerProcessingCapa11[i,*] and uses the generated PeerSelector11[i,*] to distribute the tasks to the cores #C1₁ to #C1_{N1}.

[Step S73] The scheduler executes task distribution control to the cores #C2₁ to #C2_{N2} belonging to the core set #2 by performing the same procedure as that in the processing in FIGS. 10 and 11. In this case, PeerProcessingCapa12[i,*] and PeerSelector12[i,*] are used. In the task distribution control, the scheduler collects the processing capacities from the cores #C2₁ to #C2_{N2} and generates PeerProcessingCapa12[i,*]. The scheduler generates PeerSelector12[i,*] based on the generated PeerProcessingCapa12[i,*] and uses the generated PeerSelector12[i,*] to distribute the tasks to the cores #C2₁ to #C _{N2}.

[Step S74] The scheduler executes task distribution control to the cores #C 3ᵢ to #C3_{N3} belonging to the core set #3 by performing the same procedure as that in the processing in FIGS. 10 and 11. In this case, PeerProcessingCapa13[i,*] and PeerSelector13[i,*] are used. In the task distribution control, the scheduler collects the processing capacities from the cores #C3₁ to #C3_{N3} and generates PeerProcessingCapa13[i,*]. The scheduler generates PeerSelector13[i,*] based on the generated PeerProcessingCapa13[i,*] and uses the generated PeerSelector13[i,*] to distribute the tasks to the cores #C3₁ to #C3_{N3}.

According to Variation Example 3 as described above, a core set allocated to a function is handled as a unit, and task distribution may thus be performed such that loads are distributed with high precision among the cores within the core set. Therefore, the processing efficiency by each of the core sets increases, and the performance of the entire processing by the I/O control unit 110 may be improved as a result.

Examples of processes for storage control corresponding special functions may include followings.

In the storage control apparatus 100, data to undergo I/O processing is divided into data units each having a predetermined length for handling. The data unit is also a unit for overlap exclusion. The I/O processing unit 114 in the I/O control unit 110 temporarily additionally stores a data unit having undergone overlap exclusion in a buffer having a predetermined size within the storage control apparatus 100 before writing the data unit to the storage 300. When a plurality of data units is stored and no more data units are added to the buffer, the I/O processing unit 114 writes the plurality of data units within the buffer collectively to the storage 300. The control by using such log structured data may reduce the number of times of writing to the storage 300. For example, when an SSD is used as a storage device for the storage 300, the reduction of the number of times of writing to the SSD may extend the life of a flash memory included in the SSD.

In the writing control, the invalid data of the data stored in the storage 300 is invalidated by garbage collection, and the area having stored the data may be re-used. In the garbage collection processing, the release of the area of the invalidated data is to be executed at a higher speed than the speed of occurrence of new write data. Otherwise, at a certain point in time, the execution of I/O processing may have to be waited, or an I/O request may have to be rejected. For that, the execution of tasks corresponding to the garbage collection desirably has high priority. Accordingly, the garbage collection processing is applied as the processing corresponding to the special function so that the garbage collection may be executed in a stable manner at a predetermined speed by using a special core set, without any influence by processing loads of other functions.

### Variation Example 4

According to Variation Example 3, in both of a core set implementing a special function and a core set implementing a generic function, distribution control is performed over the cores included in the core sets such that the loads among the cores may be leveled based on the processing capacities of the cores. However, in a core set implementing a special function, tasks may be simply equally distributed among the cores. This may reduce the processing load for the task distribution control in the core set and may increase the performance of the task execution for the special function. Because tasks for a special function belong to a specific type, processing details of the tasks may be close. Thus, the loads among the cores may easily be balanced. Therefore, even when tasks are equally distributed among the cores, there is a low possibility that the loads among the cores are largely unbalanced.

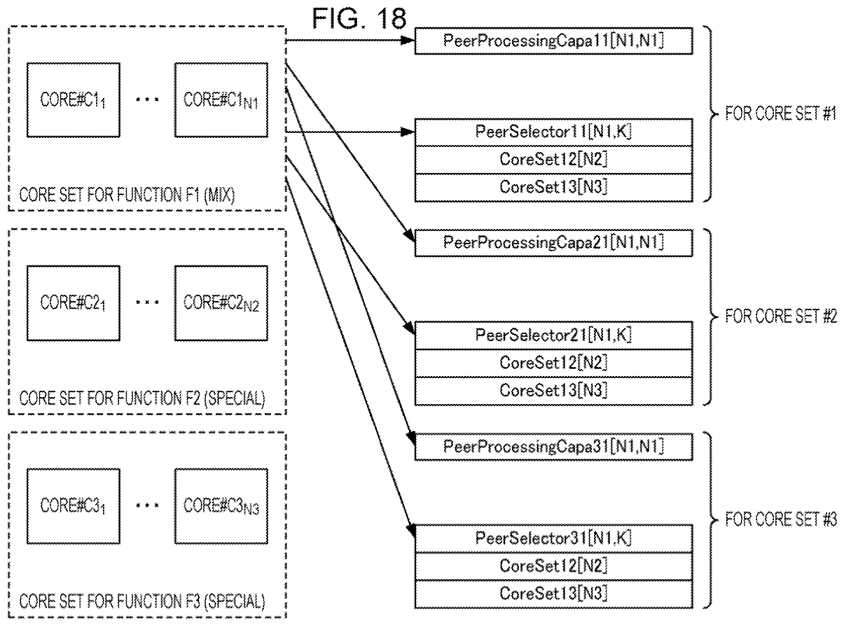

FIG. 18 is a diagram illustrating a configuration example of a function-based cores and sequences to be used according to Variation Example 4. In the example in FIG. 18, like FIG. 16, the cores in the CPU 101 are divided into a core set #1 allocated to a function F1, a core set #2 allocated to a function F2, and a core set #3 allocated to a function F3.

The tasks corresponding to the function F1 are distributed among the cores #C1₁ to #C1_{N1} within the core set #1, like Variation Example 3, such that the load balance may be leveled among the cores #C1₁ to #C1_{N1}. Therefore, K tasks of the type corresponding to the function F1 are distributed to the cores #C1₁ to #C1_{N1} belonging to the core set #1 by using PeerProcessingCapa11[N1,N1] and PeerSelector11[N1,K]. K tasks of the type corresponding to the function F1 are distributed to the cores #C1₁ to #C1_{N1} belonging to the core set #2 by using PeerProcessingCapa21[N1,N1] and PeerSelector21[N1,K]. K tasks of the type corresponding to the function F1 are distributed to the cores #C1₁ to #C1_{N1} belonging to the core set #3 by using PeerProcessingCapa31[N1,N1] and PeerSelector31[N1,K].

On the other hand, tasks corresponding to the function F2 are distributed to the cores #C2₁ to #C2_{N2} belonging to the core set #2 by an equal probability. For the distribution control, CoreSet12[N2] being a core selection sequence (sequence having one row and N2 columns) having N2 elements is used commonly among the core sets #1 to #3. The matrix PeerProcessingCapa is not used.

Tasks corresponding to the function F3 are distributed to the cores #C3₁ to #C3_{N3} belonging to the core set #3 by an equal probability. For the distribution control, CoreSet13[N3] being a core selection sequence (sequence having one row and N3 columns) having N3 elements is used commonly among the core sets #1 to #3. The matrix PeerProcessingCapa is not used.

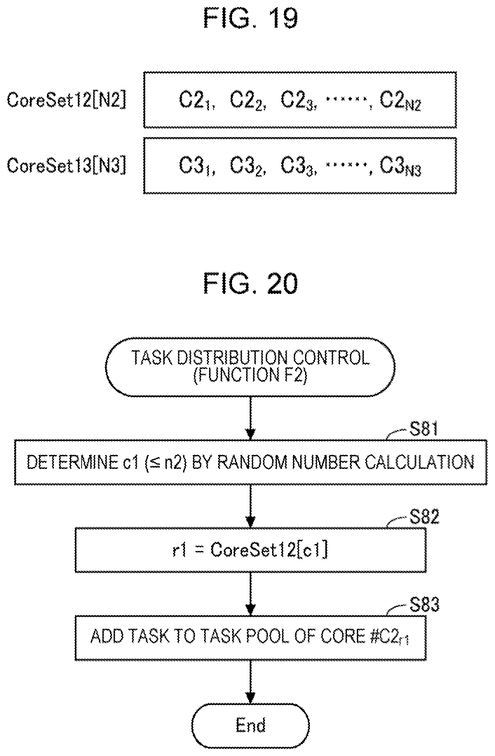

FIG. 19 is a diagram illustrating an example of core selection sequences for equal distribution. CoreSet12[N2] to be used for equally distributing tasks corresponding to the function F2 sequentially has one core number of the cores #C2₁ to #C2_{N2} belonging to the core set #2. CoreSet13[N3] to be used for equally distributing tasks corresponding to the function F3 sequentially has one core number of the cores #C3₁ to #C3_{N3} belonging to the core set #3. These CoreSet12[N2] and CoreSet13[N3] may be generated in advance and be stored in the storage unit 130.

FIG. 20 is an example of a flowchart illustrating a part of task distribution control processing according to Variation Example 4. In Variation Example 4, processing in FIG. 20 is executed instead of step S73 illustrated in FIG. 17.

[Step S81] The scheduler calculates an integer equal to or lower than N2 by the random number calculation and determines the value as the variable c1.

[Step S82] The scheduler reads out CoreSet12[c1] (numerical value at the c1st column in CoreSet12) and sets the read value to the variable r1.

[Step S83] The scheduler adds the task to the task pool corresponding to the core #C2ᵣ₁ having the core number #r1 among the core #C2₁ to #C2_{N2} belonging to the core set #2.

In Variation Example 4, instead of step S47 illustrated in FIG. 18, processing applying the processing in FIG. 20 to the function F3 is executed. In this processing, the variable c1 equal to or lower than N3 is determined in step S81, and CoreSet13[c1] is set to the variable r1 in step S82. The task is added to the task pool corresponding to the core 3₁ belonging to the core set #3 in step S83.

### Variation Example 5

In the processing according to Variation Example 4 illustrated in FIG. 20, the random number calculation (calculation of the variable c1) is performed every time a task corresponding to the function F2 occurs. On the other hand, according to Variation Example 5, the random number table 134 is used for determining the distribution destination of a task corresponding to the function F2 (and function F3) so that the number of times of execution of the random number calculation may be reduced and that the processing load of the task distribution control may be reduced.

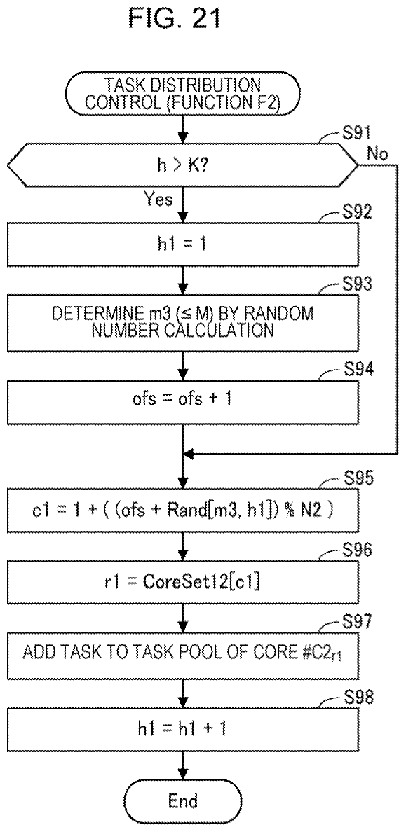

FIG. 21 is an example of a flowchart illustrating a part of task distribution control processing according to Variation Example 5. In Variation Example 5, processing in FIG. 21 is executed instead of step S73 illustrated in FIG. 17. Referring to FIG. 21, like FIG. 17, the process by the scheduler corresponding to the i-th core belonging to the core set #1 will be described. In other words, for example, when a task corresponding to the function F2 occurs the scheduler, the processing in FIG. 21 is executed on the task.

[Step S91] The scheduler determines whether a variable h1 is higher than K. If the variable h1 is higher than K, the scheduler executes processing in step S92. If the variable h1 is equal to or lower than K, the scheduler executes processing in step S95. The variable h1 has an initial value that is an arbitrary integer higher than K. Though the value of K is the same as the value K used for the distribution control over a task corresponding to the function F1 as an example, the value of K may be a different value.

[Step S92] The scheduler sets the variable h1 to 1.

[Step S93] The scheduler calculates an integer equal to or lower than M by the random number calculation and determines the value as the variable m3.

[Step S94] The scheduler adds 1 to an offset value ofs and updates the offset value ofs. The offset value ofs is a numerical value having K as an upper limit and is reset to 0 if the offset value ofs has a value higher than K as a result of the addition of the step S94. The offset value ofs has an initial value being an arbitrary integer equal to or higher than 0 and equal to or lower than K.

[Step S95] The scheduler calculates the variable c1 by using the following Expression (6). An operator “%” indicates a residue calculation.

c1=1+((ofs+Rand[m3,h1]%N2) (6)

[Step S96] The scheduler reads out CoreSet 2[c1] (numerical value at the c1st column in CoreSet12) and sets the read value to the variable r1.

[Step S97] The scheduler adds the task to the task pool corresponding to the core #C2ᵣ₁ having the core number #r1 among the core #C2₁ to #C2_{N2} belonging to the core set #2.

[Step S98] The scheduler increases the variable h1 by 1.

In the processing in FIG. 21 as described above, for distributing K tasks corresponding to the function F2, a random number equal to or lower than M is calculated once by the random number calculation in step S93. The distribution destinations of the K tasks are finally determined by using the random number table 134 in step S95. This reduces the processing load of the random number calculation so that the influence of the processing load on the storage control performance by the I/O control unit 110 may be reduced. As a result, the storage control performance by the I/O control unit 110 may be improved. Because the processing load of the random number calculation is reduced and at the same time the randomness of the selection of core numbers may be improved as described above, the precision of the load distribution in the cores #C2₁ to #C2_{N2} may be increased.

Expression (6) is used to calculate a random integer equal to or lower than N2 based on a sum value acquired by adding the offset value ofs to the value at the m3rd row and h1st column in the random number table 134. The offset value ofs is updated every time K tasks corresponding to the function F2 are distributed. If K is lower than the number (N2) of cores belonging to the core set #2, the offset value ofs functions as a correction value for keeping the randomness of the variable c1. Therefore, if K is equal to or higher than N2, the variable c1 may not be used. In this case, the execution of step S94 is not required. With that, the offset value ofs is set to the fixed value 0, or the addition of the offset value ofs is deleted from the Expression (6).

In step S94, a random numerical value equal to or lower than K is calculated by the random number calculation to set the offset value ofs.

In Variation Example 5, instead of step S47 illustrated in FIG. 18, processing applying the processing in FIG. 21 to the function F3 is executed. In this processing, the variable c1 equal to or lower than N3 is determined in step S95, and CoreSet13[c1] is set to the variable r1 in step S96. The task is added to the task pool corresponding to the core #C3ᵣ₁ belonging to the core set #3 in step S97.

A comparison between work stealing that is a kind of dynamic load distribution and the processing above will be described. In work stealing, a set of tasks is managed by the entire system. Therefore, exclusive control is required for task registration or for taking out a task. The processing load of the exclusion control is large. According to the second embodiment and Variation Examples 1 to 4 thereof, a task pool is separately provided for a core, and each core independently registers task with the task pool and takes out a task from the task pool. Thus, exclusion control is not required for the task registration and for taking out a task, and the processing efficiency of the task distribution control may be increased, compared with work stealing.

The processing functions of the apparatuses (for example, the information processing apparatuses 1 and the storage control apparatuses 100 and 200) illustrated in each of the above embodiments may be implemented by a computer. In that case, there is provided a program describing the processing contents of functions that each apparatus includes, and by executing the program by the computer, the processing functions are implemented over the computer. The program in which the content of processing is written may be recorded on a computer-readable recording medium. The computer-readable recording medium includes a magnetic storage device, an optical disk, a magneto-optical recording medium, a semiconductor memory, and the like. Examples of the magnetic recording, device include a hard-disk device (HDD) and a magnetic tape. Examples of the optical disk include a compact disc (CD), a digital versatile disc (DVD), and a Blu-ray Disc (BD) (registered trademark). One example of the magneto-optical recording medium is a magneto optical (MO) disk.

When the program is to be distributed, for example, portable recording media, such as DVDs and CDs, on which the program is recorded are sold. The computer program may be stored in a recording device of a server computer and transferred from the server computer to another computer through a network.

The computer that executes the program, for example, stores the program recorded in the portable recording medium or the program transferred from the server computer in its own storage device. Then, the computer reads the program from its own storage device and executes processing according to the program. The computer may read the program directly from the portable recording medium and execute the processing according to the program. Each time the program is transmitted from a server computer coupled via a network, the computer may sequentially execute processing according to the received program.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing apparatus comprising:
a plurality of processors communicatively coupled to each other, each of the plurality of processors configured to independently execute a task distribution process including
collecting processing capacities of the plurality of processors, and
distributing a predetermined number of tasks to the plurality of processors with distribution probabilities corresponding to respective ratios of the collected processing capacities.

2. The information processing apparatus of claim 1, further comprising a memory configured to store a plurality of random number sequences each including the predetermined number of elements, wherein:
each of the plurality of random number sequences is identified by an integer value ranging from 1 to a first number, the first number indicating a number of random number sequences included in the plurality of random number sequences; and
the task distribution process includes:
randomly generating a first integer value equal to or lower than the first number,
selecting a first random number sequence identified by the first integer value from the plurality of random number sequences, and
distributing the predetermined number of tasks by using the fire random number sequence.

3. The information processing apparatus of claim 2, wherein
the task distribution process further includes:
generating an identification number sequence including the predetermined number of elements each storing an identification number identifying a processor of the plurality of processors, a number of elements storing the same identification number being determined in accordance with a ratio of the processing capacity of the processor;
selecting a random number one by one from the first random number sequence every time a first task among the predetermined number of tasks occurs,
reading a first identification number stored in an element of the identification number sequence which is identified by the selected random number, and
distributing the first task to a first processor among the plurality of processors which is identified by the first identification number.

4. The information processing apparatus of claim, wherein
the task distribution process includes:
randomly generating a second integer value equal to or lower than the first number, and
cyclically selecting, as the random number, a first random number from an element of the first random number sequence which is identified by the second integer value.

5. The information processing apparatus of claim 1, wherein
the information processing apparatus includes a plurality of processor sets each including a plurality of processors, each of the plurality of processor sets being associated with different one of task types;
a task type of a task among the predetermined number of tasks is identified each time the task occurs; and
a distribution destination of the task is determined by executing the task distribution process independently on each of processors associated with the identified task type.

6. The information processing apparatus of claim 1, wherein:
the information processing apparatus includes a plurality of processor sets each including a plurality of processors, each of the plurality of processor sets being associated with different one of task types and classified into two groups including a first group and a second group;
a task type of a task among the predetermined number of tasks is determined each time the task occurs;
when the task type is determined to be a first task type associated with processors included in the first group, a distribution destination of the task is determined by executing the task distribution process independently on each of processors associated with the first task type; and
when the task type is determined to be a second task type associated with processors included in the second group, the task is randomly distributed to processors associated with the second task type.

7. A non-transitory, computer-readable recording medium having stored therein a program for causing a computer including a plurality of processors to execute a process comprising:
causing each of the plurality of processors that are communicatively coupled to each other to independently execute a task distribution process including
collecting processing capacities of the plurality of processors, and
distributing a predetermined number of tasks to the plurality of processors with distribution probabilities corresponding to respective ratios of the collected processing capacities.

8. The non-transitory, computer-readable recording medium of claim 7, the process further comprising:
providing a plurality of random number sequences each including the predetermined number of elements, wherein
the task distribution process includes:
randomly generating a first integer value equal to or lower than the first number,
selecting a first random number sequence identified by the first integer value from the plurality of random number sequences, and
distributing the predetermined number of tasks by using the first random number sequence.

9. The non-transitory, computer-readable recording medium of claim 8, wherein the task distribution process further includes:
generating an identification number sequence including the predetermined number of elements each storing an identification number identifying a processor of the plurality of processors, a number of elements storing the same identification number being determined in accordance with a ratio of the processing capacity of the processor;
selecting a random number one by one from the first random number sequence every time a first task among the predetermined number of tasks occurs;
reading a first identification number stored in an element of the identification number sequence which is identified by the selected random number; and
distributing the first task to a first processor among the plurality of processors which is identified by the first identification number.

10. The non-transitory, computer-readable recording medium of claim 9, wherein the task distribution process includes:
randomly generating a second integer value equal to or lower than the first number, and
cyclically selecting, as the random number, a first random number from an element of the first random number sequence which is identified by the second integer value.

11. The non-transitory, computer-readable recording medium of claim 7, wherein:
the computer includes a plurality of processor sets each including a plurality of processors, each of the plurality of processor sets being associated with different one of task types;
a task type of a task among the predetermined number of tasks is identified each time the task occurs and
a distribution destination of the task is determined by executing the task distribution process independently on each of processors associated with the identified task type.

12. The non-transitory computer-readable recording medium of claim 7, where in:
the computer includes a plurality of processor sets each including a plurality of processors, each of the plurality of processor sets being associated with different one of task types and classified into two groups including a first group and a second group;
a task type of a task among the predetermined number of tasks is determined each time the task occurs;
when the task type is determined to be a first task type associated with processors included in the first group, a distribution destination of the task is determined by executing the task distribution process independently on each of processors associated with the first task type; and
when the task type is determined to be a second task type associated with processors included in the second group, the task is randomly distributed to processors associated with the second task type.

13. An information processing apparatus comprising:
a plurality of processors communicatively coupled to each other,
the plurality of processors including at least a first processor and a second processor,
the first processor and the second processor configured to
respectively calculate ratios of processing capacities of the plurality of processors during a time period in which a predetermined number of tasks are executed;
execute distribution of tasks when a new task occurs during the time period from execution of at least one of the predetermined number of tasks based on the calculated ratios.

14. The information processing apparatus according to claim 13, wherein
the first processor calculates first ratios of processing capabilities of the plurality of processors, and
the second processor calculates second ratios of processing capabilities in parallel with the calculation by the first processor, but starting calculation of the second ratios at a time within the time period after the first processor has started calculation of the first ratios.

15. The information processing apparatus according to claim 14, wherein the tasks are distributed based on each of the first ratios and the second ratios during the time period to reduce load distribution inequalities between the plurality of processors that are created from load balance changes occurring during the time period.

16. The information processing apparatus according to claim 13, wherein each processing capability is a reserve capacity of a processor acquired by subtracting a usage rate of the processor from 100%.

17. The information processing apparatus according to claim 13, wherein
the memory stores a random number table having a plurality of rows of random numbers and a number of columns equal to the predetermined number of tasks,
the processor randomly generates an integer value equal to or lower than the predetermined number of tasks,
selects a row from the random number table based on the generated integer value, and
begins execution of the distribution of tasks based on the selected row.
